(19) United States
(12) Patent Application Publication
(10) Pub. No.: US 2025/0094410 A1
(43) Pub. Date: Mar. 20, 2025

(54) MAXIMIZING INFORMATION GAIN OF THE JOINT ENVIRONMENT KNOWLEDGE AT CROWDED EDGE APPLICATIONS

(71) Applicant: Dell Products L.P., Round Rock, TX (US)

(72) Inventors: Werner Spolidoro Freund, Rio de Janeiro (BR); Paulo Abelha Ferreira, Rio de Janeiro – RJ (BR); Julia Drummond Noce, Rio de Janeiro – RJ (BR); Pablo Nascimento da Silva, Niterói – RJ (BR); Vinicius Michel Gottin, Rio de Janeiro – RJ (BR)

(21) Appl. No.: 18/466,890

(22) Filed: Sep. 14, 2023

(51) Int. Cl. G06F 16/23; G06F 9/48; G06F 16/29

(52) U.S. Cl. CPC G06F 16/2379; G06F 9/4843; G06F 16/29

(57) ABSTRACT

One example method includes performing, in a global environment that includes a central node and edge nodes that are able to communicate with each other, by the central node, operations including: sampling optimal information from the edge nodes concerning a state of the global environment, based on the optimal information, updating a global map of the global environment, based on the optimal information, updating an information retrieval cost, using the state of the global environment to orchestrate placement and execution of one or more tasks and actions in the global environment, using the updated global map, information retrieval cost, tasks and actions to update an attention mechanism operable to control retrieval of next optimal information, and selecting next optimal information for retrieval.

### FIELD OF THE INVENTION

Embodiments of the present invention generally relate to obtaining information concerning the state and operation of a physical environment. More particularly, at least some embodiments of the invention relate to systems, hardware, software, computer-readable media, and methods for a central node to efficiently determine which grouping of edge nodes in a physical environment will maximize the knowledge, by the central node, of the state of the physical environment, given a particular set of tasks that are executing in that physical environment.

### BACKGROUND

One edge space that has attracted interest is smart services for mobile edge units, for instance, in the logistic or retail space, where there may be multiple agents under orchestration to perform a variety of tasks. One such environment might include a central near-edge processing node that orchestrates a set of tasks and actions to be performed in the environment and a large fleet of agents as far-edge mobile units. These units have sensing capabilities that are communicated via shared channels to the near-edge node which integrates them in the form of a global map to monitor and orchestrate tasks in the environment. Static sensors may be employed in the environment, such as security cameras for example. While such physical environments may be beneficial in some respects, various problems remain.

For example, it may be difficult to keep the representation of the global map in the near-edge node, relevant for the tasks under execution, as accurate and synchronized as possible with respect to the actual environment. Another problem relates to the number of far-edge nodes. In particular, problems may arise when the number of far-edge nodes is large enough to exceed the communication bandwidth of the shared channels, and/or the number of far-edge nodes is large enough to overtax the processing resources, such as memory and computation for example, available in the near-edge node.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment according to one embodiment of the invention.

FIG. 2 discloses aspects of an execution pipeline according to one example embodiment of the invention.

FIG. 3 discloses a configuration for an edge application, as disclosed in FIG. 1, according to one example embodiment of the invention.

FIG. 4 discloses aspects of a method according to one example embodiment.

FIG. 5 discloses aspects of a computing entity operable to perform any of the disclosed methods, processes, and operations.

### DETAILED DESCRIPTION OF SOME EXAMPLE EMBODIMENTS

Embodiments of the present invention generally relate to obtaining information concerning the state and operation of a physical environment. More particularly, at least some embodiments of the invention relate to systems, hardware, software, computer-readable media, and methods for a central node to efficiently determine which grouping of edge nodes in a physical environment will maximize the knowledge, by the central node, of the state of the physical environment, given a particular set of tasks that are executing in that physical environment.

In general, one example embodiment of the invention may comprise a method that determines the best set of information, arising from a group of sensors in an environment such as a physical environment, at each time step in a group of time steps. These sensors may be selected by a central near-edge node to maximize, for the central near-edge node, the joint knowledge of the environment, considering a given set of tasks executing in the environment. In this way, an embodiment may avoid collecting information from the environment that is unnecessary because that information is already known, provided by another sensor, or is not relevant or impactful for the set of tasks that is executing.

A method according to one embodiment may comprise sampling a group of nodes, such as far-edge nodes, and based on information obtained from the sampled nodes, updating an information map, which may be a global map of an environment, so as to maximize the total area of coverage of the information sampled from the far-edge nodes. The global map may be used to monitor and orchestrate tasks in the environment, and the updating may accordingly include updating the most outdated states in the environment that are relevant to perform a given set of tasks executing, or to be executed, in the environment. As well, the method may include updating an attention mechanism which operates to control retrieval of information from those regions of the environment expected to produce the most relevant information. When the various regions have been identified, the best sensors in those regions from which to obtain information, such as measurements, may be selected. When processing the measurements, the near-edge, or central, node may also update the environment state to orchestrate the tasks and actions in the environment.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the collection of extraneous or irrelevant information concerning the state of an environment may be avoided. In an embodiment, an amount of information relevant to the state of an environment may be maximized. Various other advantages of one or more example embodiments of the invention will be apparent from this disclosure.

### A. CONTEXT FOR AN EXAMPLE EMBODIMENT

One embodiment of the invention relates to the leveraging of information modelling, similar to the framework described in “N. Hubel, A. Gusrialdi, H. Fujita, and O. Sawodny, ‘Coverage Control with Information Decay in Dynamic Environments, January 2008’” (“Hubel”), which is incorporated herein in its entirety by this reference. In Hubel, a framework is applied to determine the movement of sensor-equipped mobile units to maximize coverage of targets in the environment. In contrast however, one embodiment of the invention may employ such a framework to determine which sensors maximize the information gain at a near-edge node, considering the impact that the acquisition of that information is expected to have on the tasks being performed in the environment.

### B. OVERVIEW OF AN EMBODIMENT OF THE INVENTION

One example embodiment of the invention comprises an efficient method for identifying the best far-edge nodes from which to obtain information while also mitigating the communication and processing strains, attendant to such information acquisition, in the system. An example embodiment may employ an information-based framework to select mobile edge units that best improve the joint knowledge of the environment state that is relevant for the tasks performed in that environment. This knowledge may be used, for example, to improve the operational efficiency and security in the environment.

In the context of an example embodiment of the invention, ‘information gain’ generally embraces a measure of the expectation that a specific content in the global map of an environment is in sync with the actual state of the environment. The maximization of the information gain may enable striking of a balance between two aspects relevant to the execution of the tasks in the environment, namely, the aspects of updating the most outdated states in the environment that are relevant to perform the tasks, and maximizing the total area of coverage of the information sampled from the far-edge nodes. In this way, an embodiment of the invention may avoid sampling of frivolous information, examples of which include: information from nearby far-edge nodes, that is, far-edge nodes located close to a central node; information from nodes at positions already updated in the recent past; and/or, information from nodes whose information is irrelevant to the tasks being, or to be, executed in the environment. In order to enable close-to-real-time execution, an embodiment of the invention may perform simplifications in the algorithm based on heuristics that apply to several application scenarios.

With further attention to ‘information gain,’ as used herein, information gain may be thought of as an improvement, or increase, in the knowledge concerning the state of an environment. By way of illustration, suppose that an environment is in a state1, where state1 indicates what is believed to be known about the environment. Later, updated information is obtained that provides a more accurate picture, state2, of the environment. The change, or delta, between the information about state1 and state2 may be referred to as the ‘information gain’ concerning the environment. One embodiment of the invention may thus operate to maximize an information gain relating to an environment. Further discussion of information gain is provided elsewhere herein.

In more detail, an example embodiment of the invention may comprise one or more useful aspects. For example, an embodiment may comprise a real-time algorithm that identifies, based on the maximization of information gain, the best far-edge units from which to sample measurements in an edge environment. Information indicating the most up-to-date state of the environment may be kept in a central node, such as a near-edge system or device for example. The state information may be used to orchestrate performance of specific tasks in the environment. Finally, the state information may be obtained notwithstanding that it may not be possible to sample all the far-edge units, such as sensors, as a result of there being too many sensors to practically sample.

### C. DETAILED DESCRIPTION OF ASPECTS OF AN EXAMPLE EMBODIMENT

For the purposes of facilitating the discussion, but not so as to limit the scope of the invention in any way, it may be assumed that there is a large fleet of sensor-equipped mobile far-edge units that share communication channels therefore resulting in communication and processing strains in the system. Several static sensors may be additionally employed further enhancing the computational strains in the system. It might further be assumed that these sensors may have the benefit of individual wired communication channels, but the scope of the invention extends more generally to embrace a general framework that also addresses the cases where the sensors or other devices share communication channels with the mobile far-edge units.

### C.1 Example Operating Environment

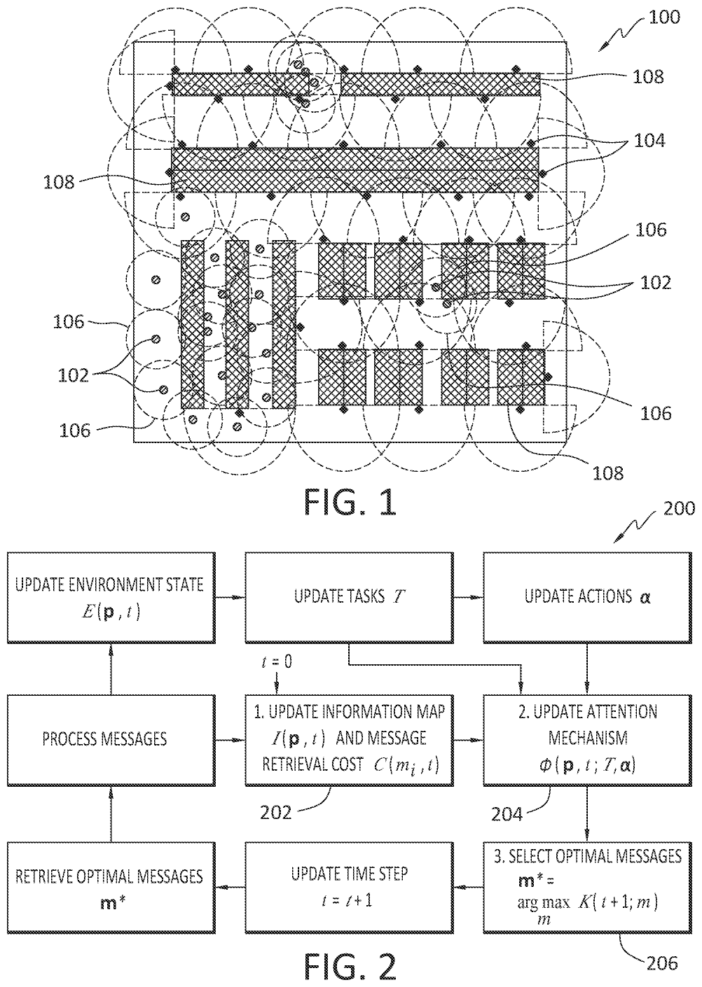

One example configuration of an environment 100, in connection with which an embodiment of the invention may be employed, is disclosed in FIG. 1. The example operating environment 100 may comprise one or more sensor-equipped mobile edge devices 102, and static, that is, non-mobile, sensors 104. The maximum area of coverage of a sensor carried by a sensor-equipped mobile edge devices 102, or of a sensor 104, is indicated by a respective dashed region 106. The shaded areas indicate space 108 that is occupied, such as with shelving, storage units, or other structures, for example. The sensor-equipped mobile edge devices 102 may not be able to travel in or through the space 108 due to the presences of such structures.

With the example environment 100 in view, one example embodiment may operate to determine the best set of information that can be obtained from a set of sensors [m*] at each time step [t] to be selected by a central near-edge node to maximize its joint knowledge [K(t)] of the environment 100, considering the set of tasks [T] in execution in the environment 100. Put another way, an embodiment of the invention may avoid the collection of unneeded extraneous information from the environment either because [1] that information is already known, [2] the information may be obtained from another sensor, and/or [3] the information is not materially related to, or needed for, the tasks in execution in the environment 100.

### C.2 Example Execution Pipeline

An example execution pipeline 200, comprising operations implemented at each time step [t], is disclosed in FIG. 2. In particular, FIG. 2 discloses an example execution pipeline 200 that may be executed by a near-edge node at each time step [t]. One example embodiment of the invention is particularly concerned with operations 1. (update information map 202), 2. (update attention mechanism 204) and 3. (select optimal messages 206), discussed in more detail below. As disclosed in FIG. 2, only the most relevant information from set of sensors [m*] for the set of tasks [T] is employed at each time step [t]. This approach may mitigate computational and communication strains in the environment 100 while also providing maximum joint knowledge returns.

It may be implicit in this approach however that the computational burden to perform the computations to select the optimal information [m*] with a method according to one embodiment must be lower than actually retrieving more, but not optimal, information [\hat{m}] by taking advantage of the extra computation budget available when employing a less expensive selection method, such as random selection or round robin for example. Under conditions of some typical edge applications, where the environment 100 size and number of devices is large enough to frequently create structures with concentration of available sensors 102/106 in given neighborhood and high dynamic behavior, then selecting [m*] instead of [\hat{m}] may yield superior results, as noted earlier herein.

As noted above, an embodiment of the invention may place emphasis on the operations, possibly performed by a central node, 202, 204, and 206 disclosed in FIG. 2, particularly, updating an information map, updating an attention mechanism, and selecting the optimal messages, from the various sensors. With regard to the messages, the information gathered by a sensor or other far-edge device may take the form of messages, some of which may be useful and some of which may be not. By selecting on a message basis, rather than a sensor basis, an embodiment of the invention may take a relatively more granular approach to the information selected for use in implementing one or more functions of an embodiment of the invention. Alternatively, however, an embodiment may select the best sensors from which to retrieve measurements.

When processing the measurements, a near-edge node, which may also be referred to herein as a ‘central node’ that communicates with far-edge systems/devices and associated sensors, may also update the environment 100 state to orchestrate the performance of tasks and actions in the environment 100. Some example algorithms for performing the operations 202, 204 and 206, are disclosed in U.S. patent application Ser. No. 18/049,700, filed Oct. 26, 2022, and titled “SO-MAP: A SEMANTIC-AWARE ALGORITHM FOR OPTIMIZING THE REPRESENTATION STRUCTURE OF OCTOMAPS” and U.S. patent application Ser. No. 18/050,274, filed Oct. 27, 2022, and titled “ORCHESTRATION OF ACTION-INPUT REPRESENTATIONS FOR DECISION MAKING IN EDGE ENVIRONMENTS,” both of which are incorporated herein in their respective entireties by this reference.

### C.3 Terms

### C.3.1 Edge Environment

Following is a discussion of some concepts and terms that are used in connection with the description of the structure and operation of an edge domain, such as the environment 100 for example. Note that while reference is made to a logistics domain, such as a warehouse for example, such reference is for the purposes of illustration, and is not intended to limit the scope of the invention in any way.
‘Near-edge node’ is a central node to which all sensors and agents are connected-the near edge node may have considerable storage and processing capabilities.
   ‘time step t∈ [symbol] +’ refers to a (discrete) update cycle of the near-edge node
   ‘message mi∈{0,1}^{li}’ is a finite binary code of length [li] transmitted through communication channels between the near-edge node and the agents or vice versa-it provides information, but at the expense of using resources
      ‘ [symbol] ={mᵢ|l(mi)≤lₘₐₓ}’ denotes the set of all possible messages that can be transmitted, where lₘₐₓ is the maximum message length and l(.) maps a message to its length
   ‘resource ri∈ [symbol] ’ is a technical component employed to provide some functionality within the environment with finite capabilities—within the context of this ID, some major resource types are:
      communication bandwidth between the near-edge node and the agents;
      computational processing power of the near-edge node;
      available (transient) memory in the near-edge node; and
      any other resources that may be applicable in a given set of circumstances,
   such as battery supply levels where battery powered components are employed.

An embodiment of the invention may refer to the set of all resources as [symbol] ={rᵢ|i∈ [symbol] +, i≤r} with [r] being the total number of finite resources.
‘agent’ is a mobile far-edge unit capable of performing local interactions with the environment—some examples of agents include, but are not limited to, Automated Mobile Robots (AMR), sensor-enhanced forklifts, augmented humans (in the sense of industry 5.0)
‘tasks T’ refer to tasks performed by the central node at each time step [t] cycle by an “update tasks” algorithm—note that the function τ(t) provides the set of tasks [T] being performed at time step [t]—the tasks may be used in the information modelling to prioritize retrieving a particular set of information, and may relate to the global management and optimization of the environment 100. Some example tasks that may be involved in an embodiment of the invention include, but are not limited to:
   planning (determining necessary action sequences by the edge nodes)—in one embodiment, a typical task in a logistics warehouse domain is to determine a loading order of packages into a truck—this task may involve, for example, the movement, loading and unloading of pallets, by multiple forklifts and AMRs;
   reasoning (informing other tasks)—inn one embodiment, a typical task that is applicable to many kinds of domains is the prediction of time-to-finish of actions—in a logistics warehouse domain, for example, the central node should typically need, for the purposes of planning and orchestration, to predict the time for an AMR to go from A to B, for the time for the AMR to unload a certain pallet, and/or the time for an AMR to load a package onto a trailer; and
   reporting and visualization—the central node may require up-to-date information of operations to generate reports to expert users.
‘actions [a]’ are local decisions required to complete a task—the function α(t) provides the set of actions [a] being performed at time step [t]—like tasks, actions may be used in the information modelling to prioritize retrieving a particular set of information—these can be computed either the near-edge node or by the agents, and some actions may be performed by the agents, but some can be triggered by the near-edge node—during the execution of an “update actions” algorithm, the actions may be communicated via a message to the agents when computed by the near-edge node, otherwise the agents may communicate their decisions to the near-edge node, or ‘central node’—some example actions in an embodiment—again with reference to the non-limiting warehouse exampl—include, but are not limited to:
   navigation and pathfinding—resolving the necessary movement to go from point A to B in the warehouse, and consider proximity sensors, LIDAR (light detection and ranging), and computer vision models to navigate around obstacles in the way;
   interacting with the environment—the agent and the near-edge node may modify the environment status—examples of interactions that may be performed by the near-edge node include, but are not limited to, opening a door, and activating alarm sounds, while agents may pick, move, drop objects, or even manually activate mechanisms within the environment, such as opening or closing doors for example; and
   parametrizing the operation of the edge node—a mobile device may determine that, based on a current context, it should operate more slowly to avoid accidents.

### C.3.2 Information Retrieval

In an embodiment, various types of information may be retrieved from various sources. Regarding information retrieval, one example embodiment may involve the following concepts.
“monitored environment” [symbol] ∈ [symbol] ³ is the region in an edge environment to be monitored, and may comprise all the space where the agents are expected to perform actions—note that the framework according to one embodiment may be equally applied when [symbol] ∈ [symbol] ² if such representation is appropriated with regard to the application requirements—in an embodiment, a point or position in the environment is denoted with p∈ [symbol]
“environment entity” is any asset or object within [symbol] ;
“sensor” sᵢ∈ [symbol] provides measurements about the state of the environment and any entities within the environment at a given time step [t].
   [symbol] ={sᵢ|i∈ [symbol] +, i≤n} denotes the set of all sensors in the environment with n being the number of sensors
   sensors can be of various types, such as cameras, depth sensors, LiDARs, RFID (radio frequency identification) readers, thermometers, acoustic sensors, and motion sensors, for example—typically, no individual sensor is able provide complete observation of an environment—static sensors only collect information about the environment, while other sensors may be carried by agents and collect information regarding the operations of the agent
   the measurements from the sensors may provided to a near-edge node via a message mi—note that while the measurements can be split in several messages such as, for example, one message per pixel, cloud point, for simplicity of exposition, the whole set of measurements provided by a sensor may be considered as a single message—note however that the framework according to one embodiment is generic and can determine which measurement point is useful to be retrieved.
   the function A(mᵢ, t) maps a message to additional context regarding the nature of the message—as such, it may be relevant for information modeling choices, as the choice of model or its parametrization, as discussed elsewhere herein—examples of such additional context include, but are not limited to: [1] properties of the sensor nature, such as its type, quality (associated uncertainty) and specific parameters of interest; [2] the position of the sensor; [3] the quality of the message or source channel, for example, how noisy or lossy is the compression applied; and, [4] other potential external interferences that might affect the message—these could be potential additional functions to be part of the modeling or affect the parametrization, as potential conditions where information from a particular sensor is known to perform poorly—one example would be a model or reparameterization considering the impact of fog, or rain, in the information retrieved from a sensor comprising a camera or LiDAR.

One “agent” may have multiple “sensors”—thus, [symbol] ₐᵢ∈ [symbol] and [symbol] [symbol] ₐᵢ∈ [symbol] respectively denote the set of sensors, and possible messages from these sensors of an agent [aᵢ].
“environment state” E(p, t) determines what is known about the environment at a given time step [t], that is, the environment state is a map of the environment as the environment exists at a time step [t]—the specific embodiment of [E] depends on the map framework employed—examples of [E] include OctoMap, SO-Map, and signed distance fields—while the specific form of the content of E(p, t) may vary with the specific embodiment employed, its state nature pertains to information related to occupancy, for example, whether a position [p] is occupied, or free, or any information which allows computing such a property, such as the occupancy probability for example—note that the algorithm “update environment state” is responsible for parsing messages from sensors and determine the current environment state S(p, t).
“budget” b(t)∈( [symbol] +)^{r} determines the total availability of resources for retrieving and processing a message—in an embodiment, the budget is a vector, where each scalar is associated to a finite resource rᵢ—the budget may be a function of the time step [t] since the near-edge node resource availability is subject to the operation of other algorithms, such as those algorithms dedicated to orchestration of the edge environment—note that the budget may be reduced by the resource requirements of the main algorithm dedicated to the selection of the best messages, and these requirements can be obtained during operation by slowly increasing parameters affecting the computational burden to find the best compromise between the algorithm efficiency and budget requirement.
“Message retrieval cost” ci=C(mᵢ, t; A): {0,1}^{li}× [symbol] +→( [symbol] +)^{r} determines the estimated cost associated with retrieving and parsing information of a given message—the nature of the message [A] may be employed to define the specific form of [C] for each [mᵢ]—the specific model may be determined empirically, by collecting the messages under experimentation and properly adjusting an appropriated function to determine the requirements in each finite resource rᵢ.

### C.3.3 Information Modeling

Referring again to Hubel, the following discussion concerns aspects of a base framework such as may be employed in an embodiment of the invention.
“Information Gain” G(p, mᵢ, t; A): [symbol] × [symbol] × [symbol] +→ [symbol] ^{+,0} is a templated function determining the expected information gain at each position p for a given message mᵢ—one example of a template for a circumstance in which the sensor uncertainty grows quadratically with distance is provided in Hubel (equation (4))—other templates may be modelled and parametrized appropriately considering the sensor particularities of each application.
“Information State Update” (below)

δ/δtl(p, t; A, τ, α): [symbol] × [symbol] ⁺→

[symbol]

computed at δt each time step.
It has an additive form δ/δtI=G−D, where the components are:
“Total Information Gain” G(p, t; A)=Σmᵢ∈m*(t) G(p, mᵢ, t; A) provides the maximum possible gain for the selected messages m*(t) at time step [t]—note that the possible message choices grow through a combinatorial problem, namely, m*∈powerset( [symbol] t), where [symbol] t∈ [symbol] are the possible message choices at time step [t]. In an unconstrained environment, the best choice is [symbol] ₜ whenever the template image is [symbol] ⁺.
“Information Decay” D(p, t; m*({1, . . . , t−1}), A, τ, α) defines the decaying behavior—it can be defined as a piece-wise function—an embodiment of the invention may allow its parametrization to be a function of:
   All the previous retrieved messages m*({1, . . . , t−1}), so that the decay can be modelled considering the specific context of a message through the usage of A; and
   The on-going tasks τ(t) and actions α(t), thus adjusting the decay strength in specific regions and accordingly to their severity.
Potential modeling choices for each compound function are:
   Linear, for example, D(p, t)=γ; and
   Exponential, for example, D(p, t)=βI(p, t−1).
“Information State Map” S(p, t; A): [symbol] × [symbol] ⁺→ [symbol] provides a value proportional to the confidence level of each environment state E(p, t). While several forms may be employed, the following modeling approach is provided as an example:

S(p, t; A)=h(I(p, t; A))

This example function [h] is a (saturating) non-linear function to model the desired behavior of maximizing the area of coverage and to avoid the information decaying indefinitely. Depending on the optimization approach employed, the saturation can be soft or hard. For example, if neural optimization is used, [h] may take the form of a sigmoid with some parametrization, for example, tanh(I(p, t; A)−5)+1) function, or a clipping function such as max(I(p, t; A), Iₘₐₓ))) if integer programming is employed. The function I(p, t; A) is the so far accumulated information, and may be initialized at t=0 with all values mapping to zero or any other boundary condition if there is a hot start mechanism.
“Mission-Oriented Attention-Mechanism” ϕ(p, t; τ, α): [symbol] × [symbol] +→[0, 1] enables control of the regions in which retrieving information is most relevant. It is noted that the parametrization based on both the tasks and actions enables the attention mechanism to optimize information retrieval considering the current action but also for possible sets of next actions, therefore balancing local, and global, decisions. It also typically takes a compound form with the number of functions fᵢ employed proportional to the tasks and actions and their complexity. A typical approach is

ϕ(p, t; τ, α)=maxᵢfᵢ(p, t; . . . ).

Possible choices for fᵢ could be, for example:
1. Mapping positions within a cylinder with radius [r] and center [c] to 1, for example (ignoring z-axis) fᵢ(p, t)={_{∈}¹ if (p−c)²<r2, otherwise. Where ∈ is a small non-zero value to allow retrieving more information on non-priority regions if remaining resources are still available;
2. As in 1., but decaying fᵢ as a function of r, as the example provided for the information gain G;
3. Other shapes can be considered, squared or rectangular base regions; and
4. The shape can also be adapted accordingly to the particular mission goal, for example, the shape may span over only navigable space when considering the task of avoiding dangerous cornering events for example.
“Mission-Aware Joint Knowledge” K(t): [symbol] ⁺→ [symbol] provides a value summarizing the total precision of the information contained in the regions that may be important for the edge application to perform the current tasks and actions, which may collectively be referred to herein as a “mission.” To focus on information that is relevant to the mission, an embodiment may consider a form composed by a convolution of the time-variant attention-based mechanism ϕ with the information state map S as in K(t; A, τ, α)=ΣₚS(p, t; A)ϕ(p, t; τ, α). It is noted that the multiplicative approach convoluting ϕ and S in such way enables ϕ to arbitrarily change while still conserving the state of previous information in S. Therefore, the edge application can appropriately select the best messages to retrieve information whenever it updates ϕ to new configurations. In other words, ϕ can be a rough approximation of the actual regions of importance and change in arbitrary ways, such as fast movement in the environment, and the optimization procedure described elsewhere herein is still able to perform well.
“Message Content Overlap” O(mi, mj): [symbol] × [symbol] → [symbol] +, 0 determines how much retrieving a message impact on the net information state gain of another message, that is O(mi, mj, t; A, τ, α)=Σₚh(G(p, mi, t; A)−G(p, mj, t; A)+I(p, t))ϕ(p, t; τ, α). Simplifications may be applied by using approximations to the immediately preceding expression. For example, an embodiment may limit computations to [symbol] ₘᵢ regions where G(p, mᵢ, t; A) is large, that is, [symbol] ₘᵢ={p|G(p, mᵢ, t; A)>ε} where ε is an arbitrary value. The [symbol] ₘᵢ regions may be referred to as core gain regions. Provided core regions [symbol] ₘᵢ and [symbol] ₘⱼ, then it is possible to return 0 and avoid above computations if either: [symbol] ₘᵢ and [symbol] ₘⱼ lies on regions where ϕ(p, t; τ, α) is sufficiently small; or [symbol] ₘᵢ does not overlap with [symbol] ₘⱼ.

### C.3.4 Example Embodiment of an Algorithm

With reference again to the example of FIG. 2, following is a discussion of the example operations 202 (“Step 1” below), 204 (“Step 2” below), and 206 (“Step 3” below).
Step 1.
   a. Set I(p, t=0; A, τ, α)=0, ∀p (only run once at initialization).
   b. Update information map: I(p, t; A, τ, α)+=_{dt}^{d}I(p, t; A, τ, α); and
   c. Estimate message retrieval cost cᵢ=C(mᵢ, t; A). This can be performed with lazy evaluation, for example, only for messages potentially selected.
Step 2. Update Mission-Oriented Attention-Mechanism ϕ(p, t; τ, α). Note that the tasks [T] and actions [a] at the current time step are computed by the near-edge node considering the environment state E(p, t) based on information obtained in the previous time-step selected messages m*(t−1).
Step 3. Determine the next best messages m* to be used from the possible messages in the current time step [symbol] ₜ by performing the maximization of the estimated mission-aware joint knowledge \hat{ }Kᵢₙ the next time step constrained by the available resource budget as in:

$$m * ( t ) = \hat{} K ( t + 1 ; A , τ , α , \hat{M} ) ,$$

subject to:

ΣC(mᵢ, t; A)<b(t)mᵢ∈ [symbol] .

### C.4 Mission-Aware Joint Knowledge Maximization

The maximization described in the aforementioned “Step 3” is a combinatorial problem over a power set of all messages available at time step t. In an embodiment, some problem-specific heuristics can be useful to reduce the computational complexity of the solution space and, consequently, the resources required to select the optimal messages m* at a given time step [t].

### C.4.1 Real-Time Execution at the Edge

This part of the discussion concerns some simplifications that may be applied in the problem to enable an embodiment to be more efficiently executed online and, therefore, enabling the embodiment to perform better than naïve approaches like round-robin and random selection. This approach considers that solely messages nearby the previously selected message are affected, therefore avoiding recomputing \hat{ }K for every remaining message whenever there is a greedy selection of a message. An embodiment of the invention may proceed in the following way:
1. Let m*(t)=Ø and [symbol] ′= [symbol] t;
2. For each message mi∈ [symbol] ′, compute the maximum expected mission-aware joint knowledge contribution kᵢ, that is, kᵢ=\hat{ }K(t+1; A, τ, α, [symbol] t=mi);
   Aggregate the contributions in a vector k={k1, . . . , k [symbol] ₜ}. Note that similar approximations as discussed for the message overlap content O(.,.) may be employed here to speedup online computation.
3. Perform the greedy selection algorithm:
   i. Pick the message with highest contribution g—the contribution can be measured as:
   a. Solely considering g=kᵢ;
   b. Some statistics of the ratio between kᵢ and its resource cost C(mᵢ, t; A), e.g. g=kᵢ/∥C(mᵢ, t; A)∥ or

$${k}_{i} / {max}_{j} \frac{{c ( {m}_{i} , t ; A )}_{j}}{} , where$$

is the remaining budget considering the already selected messages;
   c. Evaluate the resource condition:

$${\sum }_{mj ∈ mium * ( t )} C ( mj , t ; A ) < b ( t )$$

if not satisfied, stop the algorithm and return m*(t)-note that it may be possible to perform a search algorithm on messages within available budget;
   d. Let the selected message with highest contribution gᵢ be mᵢ, then append it to the selected messages m*(t)=mi∪m*(t);
   e. Remove mᵢ from [symbol] ′ₜ;
   ii. Let [symbol] ₘᵢ={mⱼ|O(mᵢ, mⱼ)>oₘᵢₙ, mⱼ∈ [symbol] ′ₜ} be the messages in which selecting mᵢ are greatly affected. Then update kⱼ−=O(mᵢ, mⱼ)∀kj∈ [symbol] ₘᵢ;
   iii. Repeat step 3.

### D. EXAMPLES

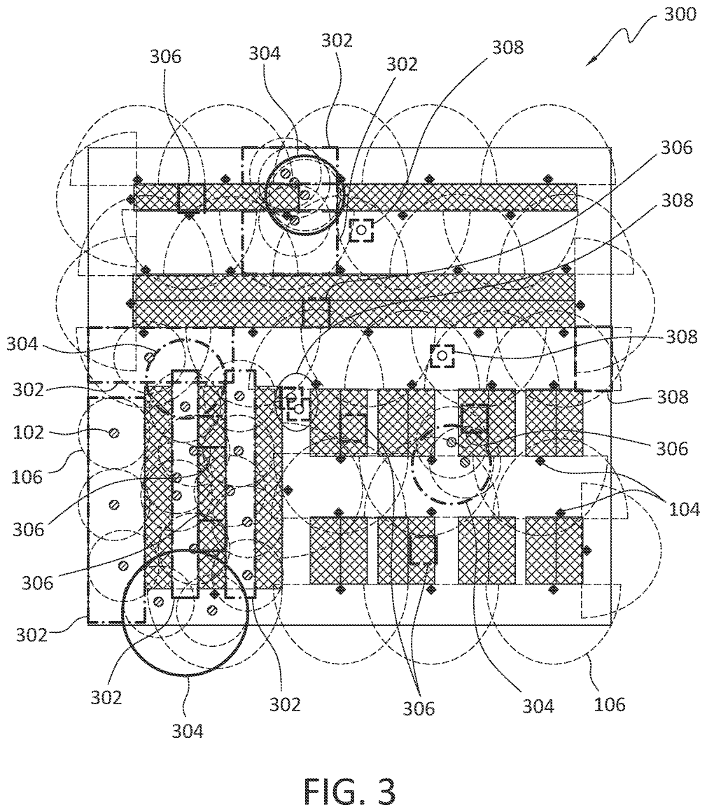

With attention now to FIG. 3, which discloses one possible environment 300 for the edge application disclosed in FIG. 1 where the continuous lines depict mission-oriented attention mechanisms ϕ(p, t; τ, α) with a different font for each task and different line widths to represent the attention scale.

In particular, it is shown how, in one embodiment, a framework may be employed based on the scenario depicted in FIG. 3. In the application of FIG. 3, the following tasks are being considered:
1. Pathing 302, indicating the path(s) traveled in the domain by one or more agents—the near-edge node may prioritize retrieving information of crowded regions by setting ϕ as a function of the density of agents in a region;
2. Dangerous cornering events 304—whenever an agent is known to path through a corner, it is possible to assign a ϕ region to collect information and ensure that it is performed properly;
3. Inventory checking 306—as part of orchestration, it might be required to check whether some part of the inventory is as expected to identify the best unit to be assigned to some task—for example, there might be changes in the inventory exact position, requiring a more precise unit to perform the task—further, the near-edge may also be interested in checking inventory to ensure that the goods are as expected and were not modified due to some external interference—by assigning ϕ to retrieve information from only the part of the inventory that is of current interest, an embodiment may successfully accomplish this task with lower resource demands;
4. Security 308—it may be important to keep the near-edge node as omniscient as possible of what happens in the environment 300 even though an embodiment may not observe the full environment—whenever an external agent, for example not a connected human, joins the environment 300, it is possible to track the external agent by setting a ϕ region to follow its position—it may also be considered to add a permanent ϕ region around entrance/exits to immediately observe the presence of such agents, but also add ϕ regions on positions that decayed to very low information levels for a given amount of time.

### E. EXAMPLE METHODS

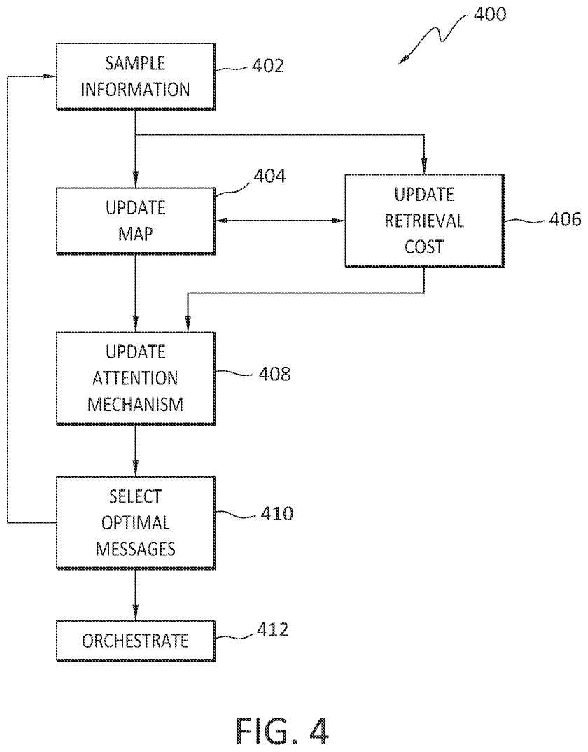

It is noted with respect to the disclosed methods, including the example method of FIG. 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 4, a method according to one example embodiment is referenced at 400. The method 400 may be performed iteratively so it should be understood that the operations disclose in FIG. 4 may be performed any number of times. In an embodiment, part or all of the method 400 may be performed by, and/or at the direction of, a central node that communicates with a group of far-edge nodes such as sensors, for example. However, the scope of the invention is not limited to any particular environment, nor to any particular elements of an environment.

The example method 400 may begin with the sampling 402 of information from one or more nodes of an environment, such as a far-edge physical environment. The environment may comprise a domain, such as a logistics warehouse for example. In an embodiment, the information may comprise one or more messages sent to/from the sampled nodes. A message may comprise, for example, information generated and/or gathered by a sensor.

The information obtained at 402 may then be used for various operations. For example, the information may be used to update 404 a map of the environment. The map may indicate a state of the environment at a particular time [t]. The state may identify, for example, what tasks are being performed in the environment, and which entities, such as far-edge devices, are performing those tasks. The state may also indicate processing, and/or other, capabilities of the devices in the environment, and an extent to which those capabilities are being utilized.

The information obtained at 402 may also be used to update 406 a retrieval cost, that is an estimated cost associated with retrieving and parsing information of a given message. A retrieval cost may be expressed in terms of the resources, such as bandwidth, computing, or storage, that would be expected to be consumed when retrieving and parsing a message. In an embodiment, the retrieval cost may be updated 406 based at least in part on the updates 404 that were made to the map.

The updated 404 map and the updated 406 retrieval cost information may then be used to update 408 an attention mechanism that operates to control retrieval of information from the region(s) of the environment that are expected to produce the most relevant information as to the state of the environment. Note that a balance may be struck between, on the one hand, updating the most outdated state(s) in the environment that are relevant to a group of tasks to be performed, or being performed, and, on the other hand, maximizing the total area of coverage of the information sampled from the nodes. Further, information retrieval may require use of far-edge resources, such as memory and bandwidth for example, that could otherwise be used for task execution by the far-edge devices, and as such, and noted earlier, the cost, in terms of resource consumption, of information retrieval may factor into decisions as to what information to retrieve, when, and from what source(s).

After the attention mechanism has been updated 408, the attention mechanism may then identify and select 410 the optimal message(s) for retrieval. Because the identified 410 messages indicate the state of the environment, the messages may be used as a basis for orchestration 412 of the placement and execution of tasks within the environment.

### F. FURTHER EXAMPLE EMBODIMENTS

Following are some further example embodiments of the invention. These are presented only by way of example and are not intended to limit the scope of the invention in any way.

Embodiment 1. A method, comprising: performing, in a global environment that includes a central node and edge nodes that are able to communicate with each other, by the central node, operations comprising: sampling optimal information from the edge nodes concerning a state of the global environment; based on the optimal information, updating a global map of the global environment; based on the optimal information, updating an information retrieval cost; using the state of the global environment to orchestrate placement and execution of one or more tasks and actions in the global environment; using the updated global map, information retrieval cost, tasks and actions to update an attention mechanism operable to control retrieval of next optimal information; selecting next optimal information for retrieval.

Embodiment 2. The method as recited in any preceding embodiment, wherein the optimal information comprises one or more messages generated by one or more edge nodes from which the optimal information was retrieved.

Embodiment 3. The method as recited in any preceding embodiment, wherein the one or more tasks and actions are executable by one or more of the edge nodes.

Embodiment 4. The method as recited in any preceding embodiment, wherein the edge nodes comprise respective agents operable to interact with the global environment.

Embodiment 5. The method as recited in any preceding embodiment, wherein updating the global map comprises updating those states of the global environment that are most out of date, and also relevant to execution of the one or more tasks and actions.

Embodiment 6. The method as recited in any preceding embodiment, wherein the optimal information comprises a maximization of information gain relative to a state of the global environment before the global map was updated.

Embodiment 7. The method as recited in any preceding embodiment, wherein a task is executing in the global environment and the operations are performed in real time as that task is executing.

Embodiment 8. The method as recited in any preceding embodiment, wherein the edge nodes comprise a combination of static sensors, and mobile sensors.

Embodiment 9. The method as recited in any preceding embodiment, wherein the next optimal information is retrieved from one or more of the edge nodes based upon an expected information gain of the next optimal information relative to the state of the global environment.

Embodiment 10. The method as recited in any preceding embodiment, wherein the next optimal information maximizes knowledge, by the central node, of the global environment, given any tasks that are executing in the global environment at a time when the next optimal information is obtained.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

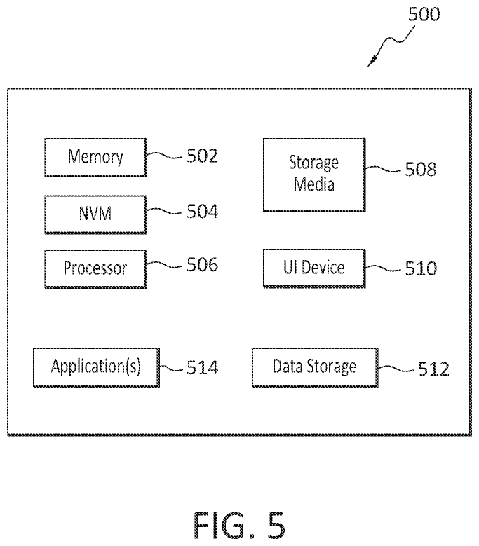

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing, in a global environment that includes a central node and edge nodes that are able to communicate with each other, by the central node, operations comprising:
sampling optimal information from the edge nodes concerning a state of the global environment;
based on the optimal information, updating a global map of the global environment;
based on the optimal information, updating an information retrieval cost;
using the state of the global environment to orchestrate placement and execution of one or more tasks and actions in the global environment;
using the updated global map, information retrieval cost, tasks and actions to update an attention mechanism operable to control retrieval of next optimal information; and
selecting next optimal information for retrieval.

2. The method as recited in claim 1, wherein the optimal information comprises one or more messages generated by one or more edge nodes from which the optimal information was retrieved.

3. The method as recited in claim 1, wherein the one or more tasks and actions are executable by one or more of the edge nodes.

4. The method as recited in claim 1, wherein the edge nodes comprise respective agents operable to interact with the global environment.

5. The method as recited in claim 1, wherein updating the global map comprises updating those states of the global environment that are most out of date, and also relevant to execution of the one or more tasks and actions.

6. The method as recited in claim 1, wherein the optimal information comprises a maximization of information gain relative to a state of the global environment before the global map was updated.

7. The method as recited in claim 1, wherein a task is executing in the global environment and the operations are performed in real time as that task is executing.

8. The method as recited in claim 1, wherein the edge nodes comprise a combination of static sensors, and mobile sensors.

9. The method as recited in claim 1, wherein the next optimal information is retrieved from one or more of the edge nodes based upon an expected information gain of the next optimal information relative to the state of the global environment.

10. The method as recited in claim 1, wherein the next optimal information maximizes knowledge, by the central node, of the global environment, given any tasks that are executing in the global environment at a time when the next optimal information is obtained.

11. A non-transitory storage medium having stored therein instructions that are executable by one or more hardware processors to:
perform, in a global environment that includes a central node and edge nodes that are able to communicate with each other, by the central node, operations comprising:
sampling optimal information from the edge nodes concerning a state of the global environment;
based on the optimal information, updating a global map of the global environment;
based on the optimal information, updating an information retrieval cost;
using the state of the global environment to orchestrate placement and execution of one or more tasks and actions in the global environment;
using the updated global map, information retrieval cost, tasks and actions to update an attention mechanism operable to control retrieval of next optimal information; and
selecting next optimal information for retrieval.

12. The non-transitory storage medium as recited in claim 11, wherein the optimal information comprises one or more messages generated by one or more edge nodes from which the optimal information was retrieved.

13. The non-transitory storage medium as recited in claim 11, wherein the one or more tasks are executable by one or more of the edge nodes.

14. The non-transitory storage medium as recited in claim 11, wherein the edge nodes comprise respective agents operable to interact with the global environment.

15. The non-transitory storage medium as recited in claim 11, wherein updating the global map comprises updating those states of the global environment that are most out of date, and also relevant to execution of the one or more tasks.

16. The non-transitory storage medium as recited in claim 11, wherein the next optimal information comprises a maximization of information gain relative to a state of the global environment before the global map was updated.

17. The non-transitory storage medium as recited in claim 11, wherein a task is executing in the global environment and the operations are performed in real time as that task is executing.

18. The non-transitory storage medium as recited in claim 11, wherein the edge nodes comprise a combination of static sensors, and mobile sensors.

19. The non-transitory storage medium as recited in claim 11, wherein the next optimal information is retrieved from one or more of the edge nodes based upon an expected information gain of the next optimal information relative to the state of the global environment.

20. The non-transitory storage medium as recited in claim 11, wherein the next optimal information maximizes knowledge, by the central node, of the global environment, given any tasks that are executing in the global environment at a time when the next optimal information is obtained.
